(19) United States
(12) Patent Application Publication
(10) Pub. No.: US 2006/0227206 A1
(43) Pub. Date: Oct. 12, 2006

(54) System for recording image onto label layer of optical disc

(75) Inventors: Wai William Wang, Taoyuan (TW); Hank Yang, Taoyuan (TW); Ta-Yuan Lee, Taoyuan (TW); Lin Hsiao, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENO Corporation

(21) Appl. No.: 11/399,774

(22) Filed: Apr. 7, 2006

(30) Foreign Application Priority Data
Apr. 8, 2005 (TW) 094111127

(51) Int. Cl. B41J 2/435

(52) U.S. Cl. 347/224

(57) ABSTRACT

The present invention provides a system and method for recording an image onto a label layer of an optical disc. The optical disc also includes a data layer thereon that has a pregroove, in which a plurality of predetermined address codes are marked. Firstly, the system locates a first position by retrieving the predetermined address codes marked on the data layer. The system then determines a second position on the label layer in accordance with the first position. Afterward, the system records the image at the second position on the label layer by means of a laser beam or ink-jet printing. Thereby, the image is formed on the label layer of the optical disc.

### BACKGROUND OF THE INVENTION

1. Field of the Invention

This present invention relates generally to optical disc image recording and, more particularly, to a system and the method for recording data, such as images, onto a label layer of an optical disc.

2. Description of the Prior Art

As the recordable optical discs, such as a CD-R (compact disk recordable) and a CD-RW (compact disk rewritable), have been extensively used for recording a large amount of information, the accompanying issue is the management of optical discs that have already recorded data. Methods for labeling the non-data side of such optical discs with text and figures, for example, have continued to develop as consumers desire more convenient ways to identify the data they've burned onto their own CDs. Generally, methods for labeling an optical disc include physically writing on the non-data side with a permanent marker (e.g. a sharpie marker) or printing out a paper sticker label and sticking it onto the non-data side of the disc. Other physical marking methods developed for implementation in conventional CD drives include ink-jet printing, thermal wax transfer, and thermal dye transfer methods.

In recent years, there has been a proposed technology, as disclosed in U.S. Pat. No. 6,864,907, in which a coloring layer that changes its color in response to heat or light is integrally provided with an optical disc; the coloring layer is provided on a label face opposite to the recording face to draw images in order to indicate the contents recorded on the optical disc. The label face is set to face an optical pickup, and a laser beam is radiated by the optical pickup to cause the coloring layer to change its color, so as to form a visible image.

The main difficulty for labeling an optical disc is that no tracks or reference marks are provided on the label side (non-data side) for automatically determining a radial position, making optical disc labeling a non-trivial task. In contrast, the data reading/writing strategy in the art of recordable optical discs is usually to form a pregroove on the optical discs. Predetermined address codes, such as absolute time in pregroove codes (ATIP codes), are marked on the pregroove; the ATIP codes provide a tracking basis to aid an optical information recording/reproducing apparatus (such as CD-RW drive) to perform data reading/writing. Typically, the predetermined address codes are represented in terms of time. For more information about the pregroove and ATIP codes, please refer to the U.S. Pat. No. 5,226,027 and “Compact Disc Recordable System Description”, the orange book in the 3rd edition, published by Philips Corporation in 1997. The detailed description will be omitted here.

In general, when users want to use an optical information recording/reproducing apparatus to record data onto the optical disc, the apparatus will first retrieve the predetermined address codes marked on the pregroove, so as to record the data. To summarize, when an optical drive is instructed to perform data reading and writing, the ATIP codes are retrieved to seek a particular section, thus simplifying the task of addressing on the data side of an optical disc.

Accordingly, one objective of the invention is to provide a system and method for recording data, such as images, onto a label layer of an optical disc. In addition, the system and method according to the invention are able to locate a specific position where an image is to be recorded on the label layer by taking advantage of the predetermined address codes on the data layer.

### SUMMARY OF THE INVENTION

According to the first preferred embodiment of the invention, a system is provided for recording an image onto a label layer of an optical disc. The optical disc also includes a data layer thereon that has a pregroove, in which a plurality of predetermined address codes are marked. The recording system, according to the invention, includes a processor, an optical pick-up unit, a label-writing unit, and a controller.

The processor is used for receiving data related to a first position defined on the data layer. The optical pick-up unit locates the first position by retrieving the predetermined address codes via a first laser beam. The label-writing unit is used for recording the image onto the label layer. The controller, which is operated by the processor, is used for controlling the optical pick-up unit to focus the first laser beam on the data layer to retrieve the predetermined address codes and for controlling the label-writing unit to record the image onto the label layer. The controller determines a second position on the label layer in accordance with the first position, and the label-writing unit is responsively positioned at the second position by the controller to record the image onto the second position on the label layer of the optical disc.

According to the second preferred embodiment of the invention, a method is provided for recording an image onto a label layer of an optical disc. The optical disc also includes a data layer thereon that has a pregroove, in which a plurality of predetermined address codes are marked. According to the recording method of the present invention, firstly, the data related to a first position defined on the data layer is received. Next, the first position is located by retrieving the predetermined address codes via a first laser beam. Afterwards, a second position is determined on the label layer in accordance with the first position, and the image is recorded onto the second position on the label layer.

The advantage and spirit of the invention may be understood by the following recitations together with the appended drawings.

### BRIEF DESCRIPTION OF THE APPENDED DRAWINGS

FIG. 1 is a sectional view showing a construction of an optical disc 1 according to a preferred embodiment of the invention.

FIG. 2 is a schematic diagram showing the configuration and function devices of a recording system 2 according to a first preferred embodiment of the invention.

FIG. 3A is a schematic diagram showing an alternate configuration of the recording system 2 shown in FIG. 2.

FIG. 3B shows another preferred embodiment of the recording system 3 shown in FIG. 3A. The diagram depicts an alternate configuration of the optical pick-up unit 35 and the optical writing unit 36 in the recording system 3 shown in FIG. 3A.

FIG. 3C shows another preferred embodiment of the recording system 3 shown in FIG. 3A. The diagram depicts an alternate configuration of the optical pick-up unit 35 and the optical writing unit 36 in the recording system 3 shown in FIG. 3A.

FIG. 3D illustrates a construction of the recording system 3 shown in FIG. 3C.

FIG. 3E illustrates another embodiment of the recording system 3 according to the invention. In this embodiment, the label-writing unit of the recording system 3 is implemented as an ink-jet head.

FIG. 4 is a flowchart showing a method for recording an image onto a label layer of an optical disc according to a second preferred embodiment of the invention.

### DETAILED DESCRIPTION OF THE INVENTION

The objective of the invention is to provide a system and method for recording data, such as images, onto a label layer of an optical disc. More particularly, the system and method, according to the invention, are capable of locating a specific position on the label layer by retrieving the predetermined address codes marked on the data layer of the optical disc. Several embodiments according to the invention will be explained hereinafter.

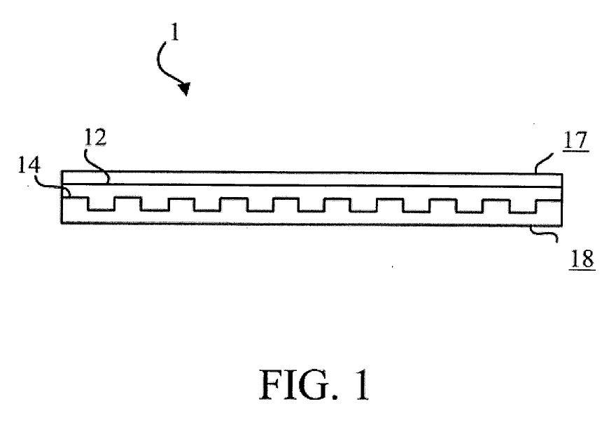

Referring to FIG. 1, FIG. 1 is a sectional view showing a construction of an optical disc 1 according to a preferred embodiment of the invention. As shown in FIG. 1, the optical disc 1 has a top surface 17 and a bottom surface 18 opposite to the top surface 17. The optical disc 1 also includes a label layer 12, which is configured to form the image in response to heat or light of a laser beam. The image can be exhibited in the form of dots or lines. In this embodiment, the label layer 12 can be formed on the top surface 17 or near the top surface 17 of the optical disc 1 by depositing special chemical coating during the manufacture of optical discs. It should be noted that FIG. 1 only shows the later case. In another embodiment, the label layer 12 can also be any types of mediums that are able to form images thereon by means of ink-jet printing, such as stickers or tags adhered to the top surface 17 of the optical disc 1. The optical disc 1 also includes a data layer 14 thereon having a pregroove in which a plurality of predetermined address codes are marked.

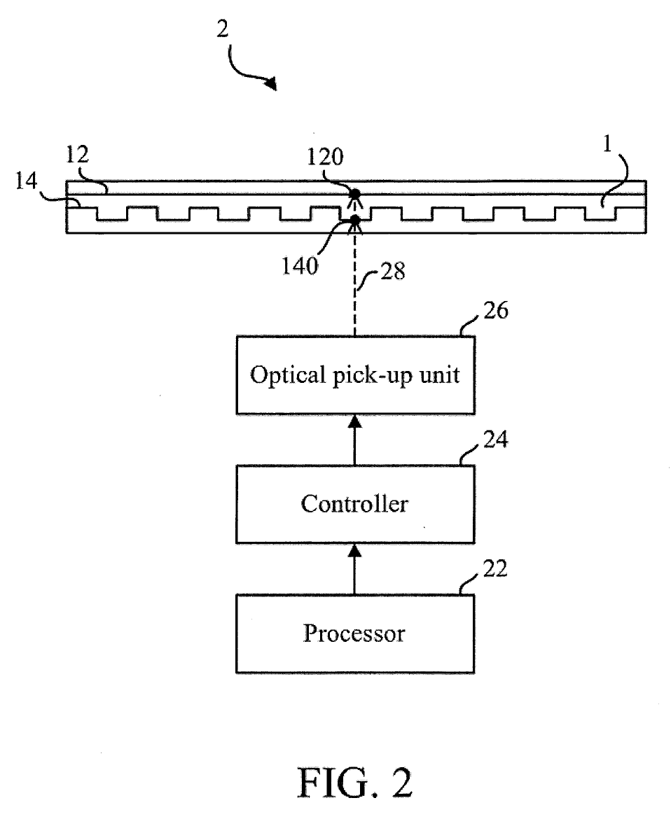

Referring to FIG. 2, FIG. 2 is a schematic diagram showing the configuration and function devices of a recording system 2 according to a first preferred embodiment of the invention. As shown in FIG. 2, the recording system 2 includes a processor 22, a controller 24, an optical pick-up unit, and a label-writing unit. It should be noted that, in this embodiment, the optical pick-up unit and the label-writing unit are the same device, which will be referred to as the optical pick-up unit 26 hereinafter.

The processor 22 is used for receiving data related to a first position 140 defined on the data layer 14. The optical pick-up unit 26 locates the first position 140 by retrieving the predetermined address codes via a first laser beam 28. The optical pick-up unit 26 is used to record the image onto the label layer 12. The controller 24, which is operated by the processor 22, is used for controlling the optical pick-up unit 26 to focus the first laser beam 28 on the data layer 14 to retrieve the predetermined address codes and also to record the image onto the label layer 12. The controller 24 determines a second position 120 on the label layer 12 in accordance with the first position 140, and the optical pick-up unit 26 is responsively positioned at the second position 120 by the controller 24 to record the image onto the second position 120 on the label layer 12 of the optical disc 1.

In this preferred embodiment, the label layer 12 is configured to form the image in response to heat or light of the first laser beam 28, and the controller 24 controls the optical pick-up unit 26 to record the image onto the label layer 12 by controlling the optical pick-up unit 26 to focus the first laser beam 28 on the label layer 12.

In practical applications, the predetermined address codes marked in the pregroove are Absolute Time In Pregroove (ATIP) codes.

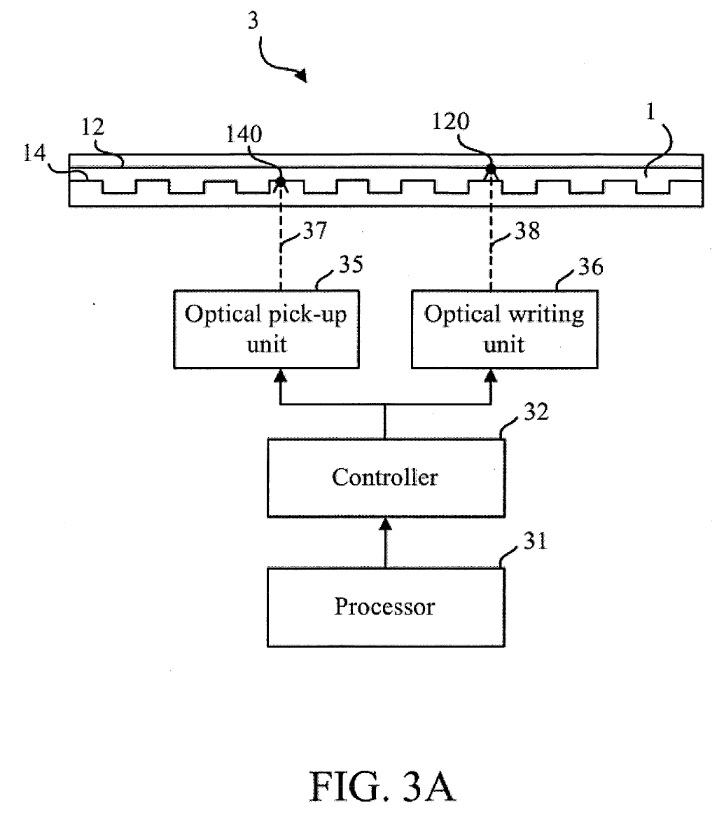

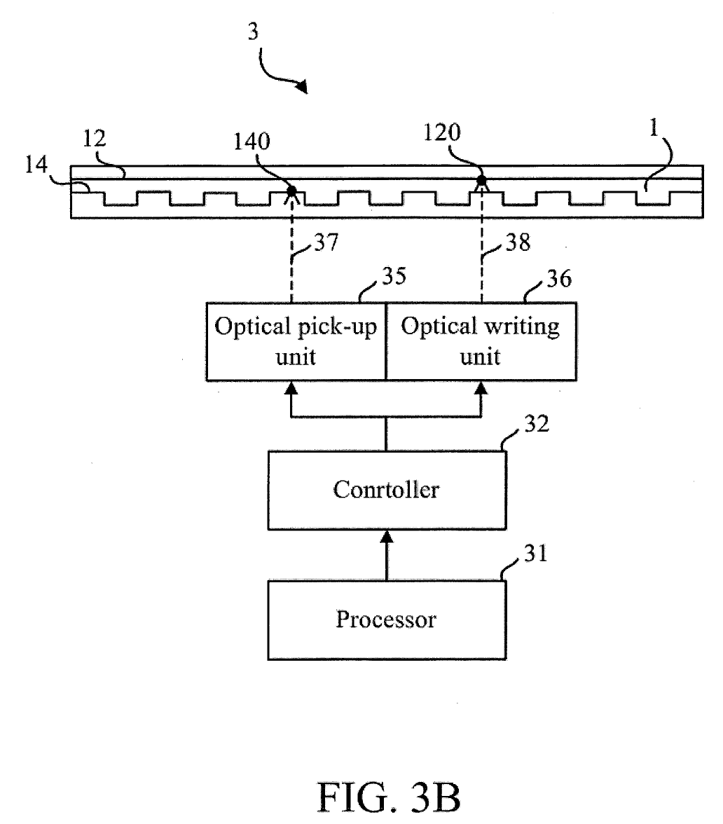

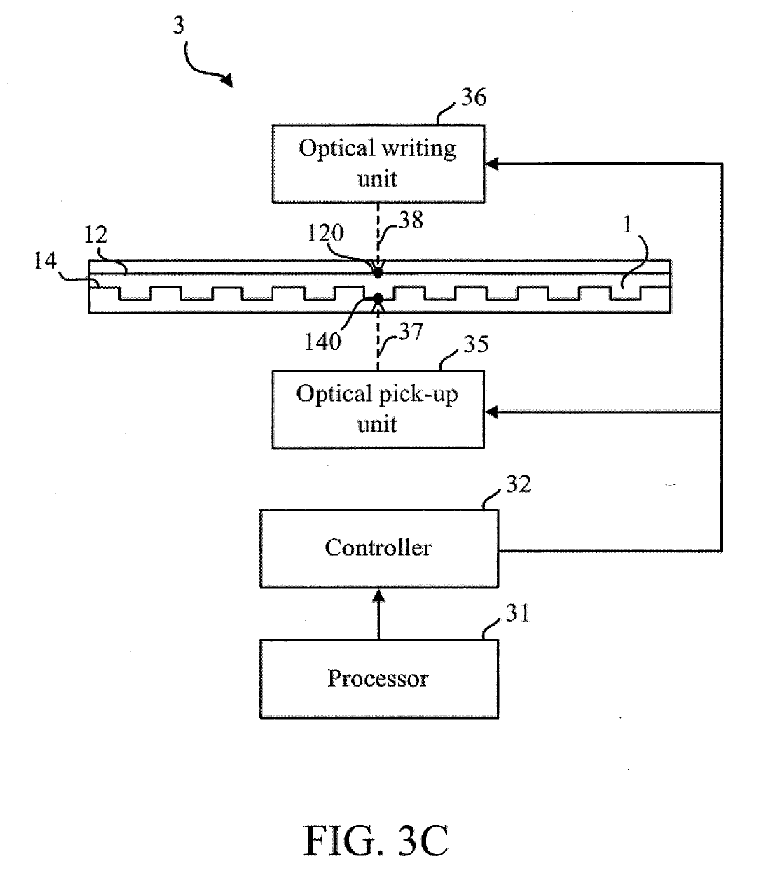

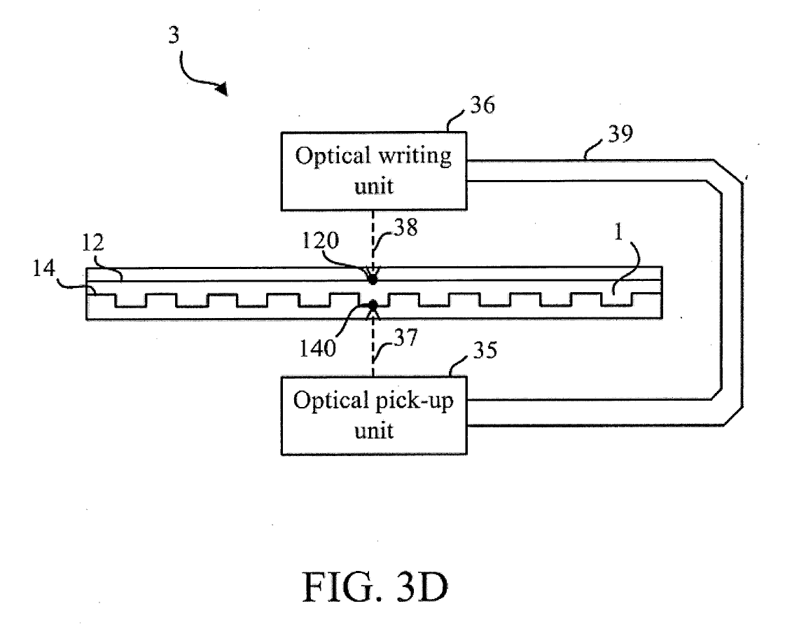

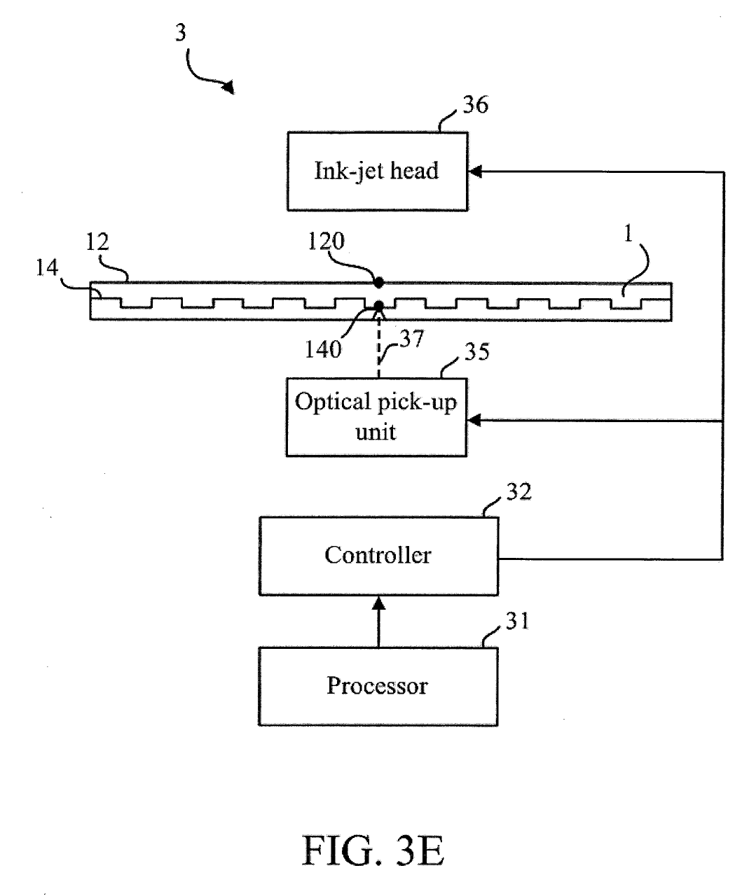

Referring to FIG. 3A, FIG. 3A is a schematic diagram showing an alternate configuration of the recording system 2 shown in FIG. 2. In this embodiment, as shown in FIG. 3A, the recording system 3 includes a processor 31, a controller 32, an optical pick-up unit 35, and a label-writing unit. It should be noted that, in this embodiment, the label-writing unit is an optical writing unit 36.

The processor 31 is used for receiving data related to a first position 140 defmed on the data layer 14. The optical pick-up unit 35 locates the first position 140 by retrieving the predetermined address codes via a first laser beam 37. The optical writing unit 36 is used to record the image onto the label layer 12. The controller 32, which is operated by the processor 31, is used for controlling the optical pick-up unit 35 to focus the first laser beam 37 on the data layer 14 to retrieve the predetermined address codes and for controlling the optical writing unit 36 to record the image onto the label layer 12. The controller 32 determines a second position 120 on the label layer 12 in accordance with the first position 140, and the optical writing unit 36 is responsively positioned at the second position 120 by the controller 32 to record the image onto the second position 120 on the label layer 12 of the optical disc 1.

In this preferred embodiment, the optical writing unit 36 is used to emit a second laser beam 38. The label layer 12 is configured to form the image in response to heat or light of the second laser beam 38, and the controller 32 controls the optical writing unit 36 to record the image onto the label layer 12 by controlling the optical writing unit 36 to focus the second laser beam 38 on the label layer 12.

In an embodiment, the optical writing unit 36 and the optical pick-up unit 35 are controlled in electrical synchronization. More specifically, the optical writing unit 36 is driven to conduct the same movement as the optical pick-up unit 35. Thereby, the optical pick-up unit 35 and the optical writing unit 36 are positioned at the first position 140 and the second position 120 respectively.

It should be noted that, in this preferred embodiment, the first position 140 and the second position 120 are not strictly related to each other. For example, the first position 140 and the second position 120 are not necessarily located on the same vertical line going through the data layer 14 and the label layer 12, which is perpendicular to the optical disc 1. The first position 140 is only a reference position by which the second position 120 on the label layer 12 is determined by the controller 32.

As shown in FIG. 3A, the optical pick-up unit 35 and the optical writing unit 36 are both disposed so as to face the bottom surface 18 of the optical disc 1 when the optical disc is installed in the recording system 3. In another embodiment, the optical pick-up unit 35 and the optical writing unit 36 can be implemented as the conjunctive device as shown in FIG. 3B. In other words, the optical writing unit 36 is mechanically coupled to the optical pick-up unit 35. In an embodiment, the optical writing unit 36 and the optical pick-up unit 35 can be coupled to each other by means of an electromagnetic member. In this way, when the recording system 3 is operated like a common optical drive, the electromagnetic member can be deactivated, and the optical pick-up unit 35 is separated from the optical writing unit 36 and can be operated alone. When an image recording process on the label layer 12 is launched, the electromagnetic member is activated to attach the optical writing unit 36 and the optical pick-up unit 35, such that the controller 32 can position the optical writing unit 36 at the second position 120 in accordance with the address codes retrieved by the optical pick-up unit 35.

In an embodiment, as shown in FIG. 3C, the optical pick-up unit 35 is disposed so as to face the bottom surface 18 of the optical disc 1 when the optical disc 1 is installed in the recording system 3, and the optical writing unit 36 is disposed so as to face the top surface 17 of the optical disc 1 when the optical disc 1 is installed in the recording system 3. It should be noted that, in this embodiment, the first position 140 and the second position 120 are not strictly related to each other. For example, the first position 140 and the second position 120 are not necessarily located on the same vertical line going through the data layer 14 and the label layer 12, which is perpendicular to the optical disc 1. The first position 140 is only a reference position by which the second position 120 on the label layer 12 is determined by the controller 32. The optical writing unit 36 and the optical pick-up unit 35 are controlled in electrical synchronization. In other words, the optical writing unit 36 is driven to conduct the same movement as the optical pick-up unit. Thereby, the optical pick-up unit 35 and the optical writing unit 36 are positioned at the first position 140 and the second position 120 respectively.

Referring to FIG. 3D, FIG. 3D illustrates a construction of the recording system 3 shown in FIG. 3C. In this embodiment, the recording system 3 further includes an arm 39 which is operated by the controller 32. The arm 39 has two opposite ends, which the optical pick-up unit 35 and the optical writing unit 36 can be attached to. The optical pick-up unit 35 and the optical writing unit 36 are disposed to face the two opposite sides of the optical disc 1 when both attached to the arm 39. More particularly, the arm 39 utilizes an electromagnetic member to attach the optical pick-up unit 35 and the optical writing unit 36. In an embodiment, the arm 39 can attach both the optical pick-up unit 35 and the optical writing unit 36 so as to perform image recording on the label layer 12. When the optical writing unit 36 is separated from the arm 39, the optical pick-up unit 35 can be operated alone to perform data reading and writing on the data layer 14 of the optical disc 1.

In another embodiment, as shown in FIG. 3E, the label-writing unit of the recording system 3 can be implemented as an ink-jet head 36. The label layer 12 of the optical disc 1 can be any types of mediums, which are able to form images thereon by means of ink-jet printing, such as stickers or tags adhered to the top surfaces 17 of the optical disc 1. In this embodiment, the optical pick-up unit 35 is disposed so as to face the bottom surface 18 of the optical disc 1 when the optical disc 1 is installed in the recording system 3, and the ink-jet head 36 is disposed so as to face the top surface 17 of the optical disc 1 when the optical disc 1 is installed in the recording system 3. The ink-jet head 36 and the optical pick-up unit 35 are controlled in electrical synchronization. In other words, the optical writing unit 36 is driven to conduct the same movement as the optical pick-up unit. Thereby, the optical pick-up unit 35 and the ink-jet head 36 are positioned at the first position 140 and the second position 120 respectively. Particularly, the arm 39 shown in FIG. 3D can also be utilized to attach the optical pick-up unit 35 and the ink-jet head 36. The operation performed in both cases are the same, and the detailed description will be omitted here.

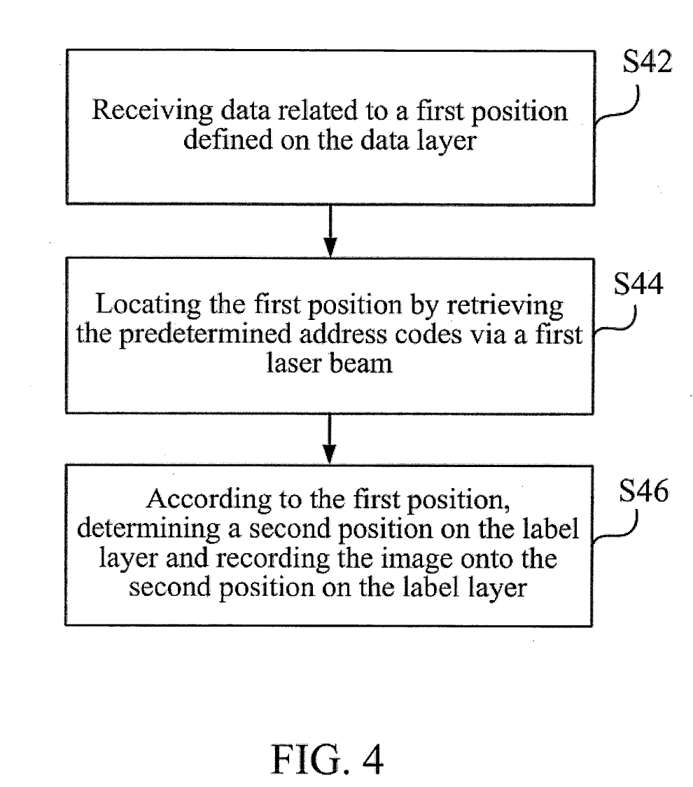

Referring to FIG. 4, FIG. 4 is a flowchart showing a method for recording an image onto a label layer of an optical disc according to a second preferred embodiment of the invention. The optical disc also includes a data layer thereon that has a pregroove in which a plurality of predetermined address codes are marked. The method, according to the second preferred embodiment of the invention, first performs step S42 to receive data related to a first position defined on the data layer. Next, step S44 is performed to locate the first position on the data layer by retrieving the predetermined address codes via a first laser beam. Afterwards, step S46 is performed to determine a second position on the label layer in accordance with the first position and to record the image onto the second position on the label layer.

In an embodiment, the label layer is configured to form the image in response to heat or light of the first laser beam. The first laser beam is focused on the data layer to retrieve the predetermined address codes or is focused on the label layer to record the image onto the second position on the label layer. The label layer can also be configured to form the image at the second position on the label layer in response to heat or light of a second laser beam other than the first laser beam. In another embodiment, an ink-jet head is utilized to record the image onto the label layer of the optical disc.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for recording an image onto a label layer of an optical disc, the optical disc also comprising a data layer thereon having a plurality of predetermined address codes are marked, said system comprising:
an optical pick-up unit for locating at a first position by retrieving the predetermined address codes via a first laser beam;
a label-writing unit for recording the image onto the label layer; and
a controller for controlling the optical pick-up unit to emit the first laser beam on the data layer to retrieve the predetermined address codes, and controlling the label-writing unit to record the image onto the label layer;
wherein the controller determines a second position on the label layer in accordance with the first position, and the label-writing unit is responsively positioned at the second position by the controller to record the image onto the second position on the label layer of the optical disc.

2. The system of claim 1, wherein the plurality of predetermined address codes, marked in a pregroove of the optical disc, are Absolute Time In Pregroove (ATIP) codes.

3. The system of claim 1, wherein the optical disc has a top surface and a bottom surface opposite to the top surface.

4. The system of claim 3, wherein the label-writing unit and the optical pick-up unit are the same device, the label layer is configured to form the image in response to heat or light of the first laser beam, and the controller controls the optical pick-up unit to record the image onto the label layer by controlling the optical pick-up unit to focus the first laser beam on the label layer.

5. The system of claim 3, wherein the label-writing unit is an optical writing unit for emitting a second laser beam, the label layer is configured to form the image in response to heat or light of the second laser beam, and the controller controls the optical writing unit to record the image onto the label layer by controlling the optical writing unit to focus the second laser beam on the label layer.

6. The system of claim 5, wherein the optical pick-up unit and the optical writing unit are both disposed so as to face the bottom surface of the optical disc when the optical disc is installed in said system.

7. The system of claim 6, wherein the optical pick-up unit and the optical writing unit are controlled in electrical synchronization.

8. The system of claim 6, wherein the optical writing unit is mechanically coupled to the optical pick-up unit.

9. The system of claim 6, wherein the optical writing unit is coupled to the optical pick-up unit via an electromagnetic member.

10. The system of claim 3, wherein the optical pick-up unit is disposed so as to face the bottom surface of the optical disc when the optical disc is installed in said system, and the label writing unit is disposed so as to face the top surface of the optical disc when the optical disc is installed in said system.

11. The system of claim 10, wherein the optical pick-up unit and the label writing unit are coupled together with an arm, the optical pick-up unit is coupled to one end of the arm, and the label writing unit is coupled to the other end of the arm.

12. The system of claim 11, further comprising an electromagnetic member for coupling the optical pick-up unit and the label writing unit to the arm when the electromagnetic member is activated, the optical pick-up unit and the label writing unit being separated from the arm when the electromagnetic member is deactivated.

13. The system of claim 10, wherein the optical pick-up unit and the label writing unit are controlled in electrical synchronization.

14. The system of claim 10, wherein the label-writing unit is an ink-jet head or an optical writing unit.

15. A method for recording an image onto a label layer of an optical disc, the optical disc also comprising a data layer thereon having a plurality of predetermined address codes are marked, said method comprising the steps of:
locating at a first position by retrieving the predetermined address codes via a first laser beam; and
according to the first position, determining a second position on the label layer and recording the image onto the second position on the label layer.

16. The method of claim 15, wherein the plurality of predetermined address codes, marked in a pregroove of the optical disc, are Absolute Time In Pregroove (ATIP) codes.

17. The method of claim 15, wherein the label layer is configured to form the image in response to heat or light of the first laser beam, the first laser beam is focused on the data layer to retrieve the predetermined address codes and focused on the label layer to record the image onto the second position on the label layer.

18. The method of claim 15, wherein the image is recorded onto the second position on the label layer via a second laser beam other than the first laser beam.

19. The method of claim 15, wherein the image is recorded onto the second position on the label layer via an ink-jet head.
